(19) United States
(12) Patent Application Publication
(10) Pub. No.: US 2024/0363868 A1
(43) Pub. Date: Oct. 31, 2024

(54) SECONDARY BATTERY AND ELECTRONIC DEVICE

(71) Applicant: Ningde Amperex Technology Limited, Ningde (CN)

(72) Inventors: Xiaoping LIN, Ningde (CN); Yuansen XIE, Ningde (CN)

(73) Assignee: Ningde Amperex Technology Limited, Ningde (CN)

(21) Appl. No.: 18/644,656

(22) Filed: Apr. 24, 2024

(30) Foreign Application Priority Data
Apr. 25, 2023 (CN) 202310451814.6

(51) Int. Cl. H01M 4/62; H01M 4/02; H01M 10/0585

(52) U.S. Cl. CPC H01M 4/625; H01M 10/0585; H01M 2004/021; H01M 2004/027

(57) ABSTRACT

A secondary battery includes a negative electrode plate and a separator. The negative electrode plate includes a three-dimensional framework. The three-dimensional framework includes a first framework layer and a second framework layer. The first framework layer includes one-dimensional conductive fibers. The second framework layer includes a zero-dimensional material, a one-dimensional material, and a two-dimensional material. The zero-dimensional material is a lithiophilic material. By adjusting and controlling the thicknesses of the three-dimensional framework, the first framework layer, and the second framework layer, the mass percent of the zero-dimensional material, and the mass ratio between the one-dimensional material and the two-dimensional material to fall within the ranges specified herein, a lithiophilic gradient is favorably constructed in the three-dimensional framework, so as to enable lithium metal to enter the interior of the three-dimensional framework and deposit from bottom upward, thereby improving the Coulombic efficiency and cycle performance of the secondary battery.

### CROSS REFERENCE TO RELATED APPLICATIONS

This application, via Paris Convention, claims priority of Chinese patent application 202310451814.6, filed on Apr. 25, 2023, the disclosure of which is hereby incorporated by reference in its entirety.

### TECHNICAL FIELD

This application relates to the field of electrochemical technology, and in particular, to a secondary battery and an electronic device.

### BACKGROUND

Secondary batteries such as a lithium-ion battery are widely used in the field of consumer electronics by virtue of advantages such as a high energy density, a high operating voltage, a low self-discharge rate, a small size, and a light weight. Among all metal elements, lithium metal is a metal with the smallest relative atomic mass (6.94) and the lowest standard electrode potential (−3.045 V). With a theoretical specific capacity of up to 3860 μmAh/g, the lithium metal is one of the metals with the highest gravimetric specific energy discovered so far. For a lithium metal battery containing a negative electrode in which the lithium metal is introduced, the energy density and operating voltage of the lithium metal battery can be improved by the use of some high-energy-density positive electrode materials (such as lithium cobalt oxide, lithium iron phosphate, lithium manganese oxide, lithium nickel cobalt manganese oxide, or lithium nickel cobalt aluminum oxide). However, the lithium metal keeps depositing during charging, thereby giving rise to lithium dendrites and dead lithium. The lithium metal also keeps expanding and shrinking during charging and discharging, thereby resulting in the peeling and fragmentation of a solid electrolyte interface (SEI) film, and in turn, impairing the Coulombic efficiency and cycle performance of the lithium metal battery.

### SUMMARY

An objective of this application is to provide a secondary battery and an electronic device to improve the Coulombic efficiency and cycle performance of the secondary battery. Specific technical solutions are as follows:

It is hereby noted that in the following description, this application is construed by using a lithium metal battery as an example of the secondary battery, but the secondary battery of this application is not limited to the lithium metal battery.

A first aspect of this application provides a secondary battery. The secondary battery includes a negative electrode plate and a separator. The negative electrode plate includes a three-dimensional framework. The three-dimensional framework includes a first framework layer and a second framework layer. The first framework layer includes one-dimensional conductive fibers. The second framework layer includes a zero-dimensional material, a one-dimensional material, and a two-dimensional material. The zero-dimensional material is a lithiophilic material. A thickness of the three-dimensional framework is 10 μm to 200 μm. A thickness of the first framework layer is 0 μm to 10 μm. A thickness of the second framework layer is 10 μm to 200 μm. Preferably, the thickness of the three-dimensional framework is 30 μm to 180 μm, and the thickness of the second framework layer is 30 μm to 80 μm. Based on a mass of the second framework layer, a mass percent of the zero-dimensional material is 1% to 30%. Preferably, the mass percent of the zero-dimensional material is 1% to 10%. A mass ratio between the one-dimensional material and the two-dimensional material is 1:7 to 20:1. By controlling the thickness of the three-dimensional framework, the thickness of the first framework layer, the thickness of the second framework layer, the mass percent of the zero-dimensional material, and the mass ratio between the one-dimensional material and the two-dimensional material to fall within the above ranges, a lithiophilic gradient is favorably constructed in the three-dimensional framework, so as to enable lithium metal to enter the interior of the three-dimensional framework and deposit from bottom upward, thereby reducing lithium dendrites and dead lithium generated, and improving the Coulombic efficiency and cycle performance of the secondary battery. In addition, the lithium metal deposited in the pores of the three-dimensional framework can suppress the volume expansion of the lithium metal, thereby improving the expansion resistance of the secondary battery.

In some embodiments of this application, the negative electrode plate includes a metallic lithium layer. The second framework layer is located between the first framework layer and the metallic lithium layer. A thickness of the metallic lithium layer is 1 μm to 100 μm. Preferably, the thickness of the metallic lithium layer is 5 μm to 50 μm. By introducing the metallic lithium layer into the negative electrode plate and controlling the thickness of the metallic lithium layer to fall within the range specified herein, this application can compensate for the loss of lithium caused by irreversible reactions in the secondary battery during an initial charge, thereby improving the cycle performance of the secondary battery.

In some embodiments of this application, a particle diameter of the zero-dimensional material is 0.1 μm to 5 μm, and preferably 0.1 μm to 1 μm. By controlling the particle diameter of the zero-dimensional material to fall within the range specified herein, this application favorably induces the lithium metal to deposit, thereby improving the Coulombic efficiency and cycle performance of the secondary battery.

In some embodiments of this application, a diameter of the one-dimensional material is 1 nm to 2000 nm, and a length-to-diameter ratio of the one-dimensional material is 0.1 to 20000. Preferably, the diameter of the one-dimensional material is 1 nm to 300 nm, and the length-to-diameter ratio of the one-dimensional material is 0.67 to 20000. More preferably, the diameter of the one-dimensional material is 1 nm to 50 nm, and the length-to-diameter ratio of the one-dimensional material is 5000 to 20000. By controlling the diameter and the length-to-diameter ratio of the one-dimensional material to fall within the range specified herein, the electron conduction is facilitated in the three-dimensional framework, thereby improving the Coulombic efficiency and cycle performance of the secondary battery.

In some embodiments of this application, a particle diameter of the zero-dimensional material is 0.1 μm to 5 μm; a diameter of the one-dimensional material is 0.001 μm to 2 μm, and the length-to-diameter ratio of the one-dimensional material is 0.1 to 20000. Preferably, the particle diameter of the zero-dimensional material is 0.1 μm to 1 μm; the diameter of the one-dimensional material is 0.001 μm to 0.3 μm, and the length-to-diameter ratio of the one-dimensional material is 0.67 to 20000. By controlling the particle diameter of the zero-dimensional material as well as the diameter and length-to-diameter ratio of the one-dimensional material to fall within the above ranges, the lithium metal is favorably induced to deposit, and the electron conduction is facilitated in the three-dimensional framework, thereby improving the Coulombic efficiency and cycle performance of the secondary battery.

In some embodiments of this application, the two-dimensional material includes titanium, carbon, and a surface group. The surface group includes at least one of —F, —O, or —OH. By selecting the above two-dimensional material, the lithium ion flow is favorably homogenized, thereby improving the homogeneity of the lithium metal deposition, and improving the Coulombic efficiency and cycle performance of the secondary battery.

In some embodiments of this application, an electrical conductivity a of the one-dimensional material satisfies: a≥1×10⁻⁶ S/cm, and an electrical conductivity b of the two-dimensional material satisfies: b≥2 S/cm, and b>a. When the electrical conductivity of the one-dimensional material and the two-dimensional material falls within the above range, the one-dimensional material and the two-dimensional material are of good electron-conducting properties. At the same time, by controlling the values of a and b and the relationship between a and b to fall within the above ranges, the one-dimensional material can constitute a conductive network in the second framework layer to improve the electronic conductivity in the three-dimensional framework. Furthermore, the zero-dimensional material, the one-dimensional material, and the two-dimensional material are of different structures, and therefore, vary in electrical conductivity and lithiophilic properties. In this way, the three-dimensional framework exhibits an electronic conductivity gradient and a lithiophilic gradient, thereby further enabling the lithium metal to deposit from bottom upward. Therefore, the secondary battery according to this application achieves relatively high Coulombic efficiency and good cycle performance.

In some embodiments of this application, the one-dimensional conductive fibers include at least one of multi-walled carbon nanotubes, carbon nanofibers, silver wire, or nickel wire. The zero-dimensional material includes at least one of a metal material, an oxide, a nitride, a sulfide, or a carbide. The metal material includes at least one of Ag, Au, Zn, or an alloy thereof. The oxide includes at least one of TiO₂, SiO₂, ZnO, SnO₂, Co₃O₄, or Fe₂O₃. The nitride includes Mo₂N₃ and/or Fe₆N₃. The sulfide includes MoS₂ and/or SnS₂. The carbide includes FeC. The one-dimensional material includes at least one of multi-walled carbon nanotubes, carbon nanofibers, a silver wire, or a nickel wire. The two-dimensional material includes MXene and/or graphene (Gr). By selecting the above one-dimensional conductive fibers, zero-dimensional material, one-dimensional material, and two-dimensional material, both an electronic conductivity gradient and a lithiophilic gradient are favorably constructed in the three-dimensional framework, thereby improving the electronic conductivity in the negative electrode plate, inducing the lithium metal to enter the interior of the three-dimensional framework and deposit from bottom upward, reducing lithium dendrites and dead lithium generated, and in turn, improving the Coulombic efficiency and cycle performance of the secondary battery.

In some embodiments of this application, a surface of the zero-dimensional material contains a wetting group. The wetting group includes at least one of —OH, —COOR, —COOH, —NH₂, or —SO₃H. The R in —COOR is selected from methyl, ethyl, propyl, vinyl, or ethynyl. The wetting group induces the lithium metal to deposit, and improves the homogeneity of the lithium metal deposition, thereby improving the Coulombic efficiency and cycle performance of the secondary battery.

In some embodiments of this application, a porosity of the three-dimensional framework is greater than or equal to 80%. By controlling the porosity of the three-dimensional framework to fall within the above range, space is favorably provided for depositing the lithium metal, thereby improving the Coulombic efficiency and cycle performance of the secondary battery.

In some embodiments of this application, a thickness change rate of the three-dimensional framework is less than 10% when the lithium metal is deposited in the three-dimensional framework at a concentration of 5 μmAh/cm². The thickness change rate falling within the above range indicates that the volume change of the three-dimensional framework is relatively small in the process of depositing lithium in the three-dimensional framework, thereby reducing the thickness expansion rate of the negative electrode plate, and in turn, achieving a relatively low thickness expansion rate of the secondary battery according to this application.

A second aspect of this application provides an electronic device. The electronic device includes the secondary battery disclosed in any one of the preceding embodiments. The secondary battery according to this application achieves relatively high Coulombic efficiency and cycle performance, and therefore, the resulting secondary battery achieves relatively high Coulombic efficiency and cycle performance.

Some of the beneficial effects of this application are as follows:

This application provides a secondary battery. The secondary battery includes a negative electrode plate and a separator. The negative electrode plate includes a three-dimensional framework. The three-dimensional framework includes a first framework layer and a second framework layer. The first framework layer includes one-dimensional conductive fibers. The second framework layer includes a zero-dimensional material, a one-dimensional material, and a two-dimensional material. The zero-dimensional material is a lithiophilic material. A thickness of the three-dimensional framework is 10 μm to 200 μm. A thickness of the first framework layer is 0 μm to 10 μm. A thickness of the second framework layer is 10 μm to 200 μm. Based on a mass of the second framework layer, a mass percent of the zero-dimensional material is 1% to 30%. A mass ratio between the one-dimensional material and the two-dimensional material is 1:7 to 20:1. The negative electrode plate of the secondary battery according to this application includes a three-dimensional framework. By controlling the thickness of the three-dimensional framework, the thickness of the first framework layer, the thickness of the second framework layer, the mass percent of the zero-dimensional material, and the mass ratio between the one-dimensional material and the two-dimensional material to fall within the above ranges, a lithiophilic gradient is favorably constructed in the three-dimensional framework, so as to enable lithium metal to enter the interior of the three-dimensional framework and deposit from bottom upward, thereby reducing lithium dendrites and dead lithium generated, and improving the Coulombic efficiency, cycle performance, and safety performance of the secondary battery. Specifically, the first framework layer improves the electronic conductivity of the three-dimensional framework. With respect to the second framework layer, on the one hand, the zero-dimensional material exhibits a tip effect and is a lithiophilic material, and is dispersed in the two-dimensional material, thereby reducing the nucleation overpotential of the lithium metal and inducing the lithium metal to deposit. On the other hand, the zero-dimensional material is a lithiophilic material, and can homogenize the lithium ion flow and improve the homogeneity of the lithium metal deposition. Furthermore, the zero-dimensional material, the one-dimensional material, and the two-dimensional material differ in structure, and therefore, vary in lithiophilic properties, thereby forming a lithiophilic gradient in the three-dimensional framework and making the lithium metal deposit from bottom upward. Moreover, the two-dimensional material is used as a matrix for the zero-dimensional material and the one-dimensional material, so that the formed three-dimensional framework possesses a high porosity and a high specific surface area, thereby providing space for the lithium metal deposition. In this way, the amount of generated lithium dendrites and dead lithium is reduced, and the Coulombic efficiency, cycle performance and safety performance of the secondary battery according to this application are improved. In addition, the lithium metal deposited in the pores of the three-dimensional framework can suppress the volume expansion of the lithium metal, thereby improving the expansion resistance of the secondary battery.

Definitely, a single product or method in which the technical solution of this application is implemented does not necessarily achieve all of the above advantages concurrently.

### BRIEF DESCRIPTION OF DRAWINGS

To describe the technical solutions in some embodiments of this application or the prior art more clearly, the following outlines the drawings to be used in the description of some embodiments of this application or the prior art. Evidently, the drawings outlined below merely illustrate some embodiments of this application, and a person of ordinary skill in the art may derive other embodiments from the drawings.

FIG. 1 is a schematic structural diagram of a three-dimensional framework according to some embodiments of this application;

FIG. 2 is a scanning electron microscope image of a three-dimensional framework according to Embodiment 1 of this application; and

FIG. 3 shows a capacity fading curve of a lithium metal battery according to Embodiment 1 and Comparative Embodiment 4 of this application.

### DETAILED DESCRIPTION

The following describes the technical solutions in some embodiments of this application clearly in detail with reference to the drawings appended hereto. Evidently, the described embodiments are merely a part of but not all of the embodiments of this application. All other embodiments derived by a person of ordinary skill in the art based on the embodiments of this application without making any creative efforts still fall within the protection scope of this application.

It is hereby noted that in the following description, this application is construed by using a lithium metal battery as an example of the secondary battery, but the secondary battery of this application is not limited to the lithium metal battery.

This application provides a secondary battery and an electronic device to improve the Coulombic efficiency and cycle life of the secondary battery. Specific technical solutions are as follows:

A first aspect of this application provides a secondary battery. The secondary battery includes a negative electrode plate and a separator. The negative electrode plate includes a three-dimensional framework. The three-dimensional framework includes a first framework layer and a second framework layer. The first framework layer includes one-dimensional conductive fibers. The second framework layer includes a zero-dimensional material, a one-dimensional material, and a two-dimensional material. The zero-dimensional material is a lithiophilic material. A thickness of the three-dimensional framework is 10 μm to 200 μm. A thickness of the first framework layer is 0 μm to 10 μm. A thickness of the second framework layer is 10 μm to 200 μm. Preferably, the thickness of the three-dimensional framework is 30 μm to 180 μm, and the thickness of the second framework layer is 30 μm to 80 μm. For example, the thickness of the three-dimensional framework may be 10 μm, 20 μm, 30 μm, 40 μm, 60 μm, 80 μm, 100 μm, 120 μm, 140 μm, 160 μm, 180 μm, 200 μm, or a value falling within a range formed by any two thereof. For example, the thickness of the first framework layer may be 0 μm, 2 μm, 4 μm, 6 μm, 8 μm, 10 μm, or a value falling within a range formed by any two thereof. For example, the thickness of the second framework layer may be 10 μm, 20 μm, 30 μm, 40 μm, 60 μm, 80 μm, 100 μm, 120 μm, 140 μm, 160 μm, 180 μm, 200 μm, or a value falling within arrange formed by any two thereof. Based on a mass of the second framework layer, a mass percent of the zero-dimensional material is 1% to 30%. Preferably, the mass percent of the zero-dimensional material is 1% to 10%. For example, the mass percent of the zero-dimensional material may be 1%, 5%, 10%, 15%, 20%, 25%, 30%, or a value falling within a range formed by any two thereof. A mass ratio between the one-dimensional material and the two-dimensional material is 1:7 to 20:1. For example, the mass ratio between the one-dimensional material and the two-dimensional material may be 1:7, 2:1, 4:1, 6:1, 8:1, 10:1, 12:1, 14:1, 16:1, 18:1, 20:1, or a value falling within a range formed by any two thereof. In this application, a lithiophilic material means a material interacting with a lithium ion and inducing lithium deposition; a zero-dimensional material means a particulate material containing particles that may be regular particles such as spherical particles or irregular particles such as quasi-spherical particles; a one-dimensional material means a wire-shaped material; and a two-dimensional material means a sheet-shaped material.

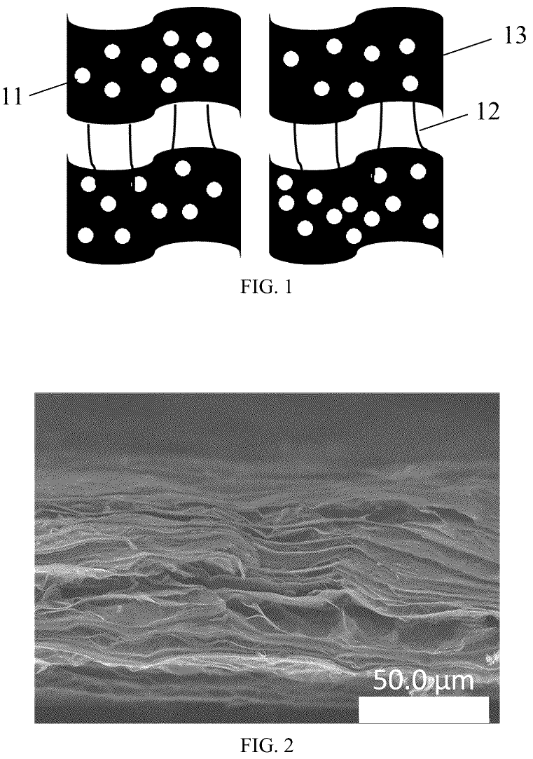

FIG. 1 is a schematic diagram of a three-dimensional framework according to some embodiments of this application. As can be seen, a zero-dimensional material 11 is particulate, a one-dimensional material 12 is wire-shaped, and a two-dimensional material 13 is sheet-shaped. The zero-dimensional material 11, the one-dimensional material 12, and the two-dimensional material 13 together form a three-dimensional framework. Specifically, the one-dimensional conductive fibers in the first framework layer improve the electronic conductivity of the three-dimensional framework. With respect to the second framework layer, on the one hand, the zero-dimensional material exhibits a tip effect and is a lithiophilic material, and is dispersed in the two-dimensional material, thereby reducing the nucleation overpotential of the lithium metal and inducing the lithium metal to deposit. On the other hand, the zero-dimensional material is a lithiophilic material, and can homogenize the lithium ion flow and improve the homogeneity of the lithium metal deposition. Furthermore, the zero-dimensional material, the one-dimensional material, and the two-dimensional material differ in structure, and therefore, vary in lithiophilic properties, thereby forming a lithiophilic gradient in the three-dimensional framework and making the lithium metal deposit from bottom upward. Moreover, the two-dimensional material is used as a matrix for the zero-dimensional material and the one-dimensional material, so that the formed three-dimensional framework possesses a high porosity and a high specific surface area, thereby providing space for the lithium metal deposition. In this way, the amount of generated lithium dendrites and dead lithium is reduced, and the Coulombic efficiency, cycle performance and safety performance of the secondary battery according to this application are improved. In addition, the lithium metal deposited in the pores of the three-dimensional framework can suppress the volume expansion of the lithium metal, thereby improving the expansion resistance of the secondary battery.

Specifically, when the thickness of the three-dimensional framework is overly small (for example, less than 10 μm), the lithiophilic gradient formed in the three-dimensional framework is not evident, and the energy difference is relatively small, thereby being unfavorable to the deposition of lithium metal, and impairing the Coulombic efficiency and cycle performance of the secondary battery. When the thickness of the three-dimensional framework is overly large (for example, greater than 200 μm), the excessive thickness is unfavorable to electron conduction in the three-dimensional framework, reduces the current density of the secondary battery, and causes side reactions, thereby impairing the Coulombic efficiency and cycle performance of the secondary battery. When the thickness of the first framework layer is overly large (for example, greater than 10 μm), the thick first framework layer adversely affects the transport of electrons and lithium ions, thereby impairing the Coulombic efficiency and cycle performance of the secondary battery. When the thickness of the second framework layer is overly small (for example, less than 10 μm), the space is not enough for depositing the lithium metal, thereby impairing the Coulombic efficiency and cycle performance of the secondary battery. When the thickness of the second framework layer is overly large (for example, greater than 200 μm), the excessive thickness reduces the current density of the secondary battery, and causes side reactions, thereby impairing the Coulombic efficiency of the secondary battery. When the mass percent of the zero-dimensional material is overly low (for example, less than 1%), the low mass percent is unfavorable to inducing lithium metal deposition in the three-dimensional framework, thereby impairing the cycle performance of the secondary battery. When the mass percent of the zero-dimensional material is overly high (for example, greater than 30%), the zero-dimensional materials are prone to be agglomerated with each other. In addition, because the zero-dimensional material is lithiophilic, the agglomeration consumes a large number of lithium ions, thereby impairing the Coulombic efficiency and cycle performance of the secondary battery. When the mass ratio between the one-dimensional material and the two-dimensional material in the three-dimensional framework is relatively low (for example, less than 1:7), that is, when the proportion of the one-dimensional material is overly low, a lithiophilic gradient can hardly be formed, thereby adversely affecting the lithium metal deposition. When the mass ratio between the one-dimensional material and the two-dimensional material in the three-dimensional framework is relatively large (for example, greater than 20:1), that is, when the proportion of the two-dimensional material is overly low, the two-dimensional material is unable to support the three-dimensional framework, thereby reducing the uniformity of distribution of the zero-dimensional material in the three-dimensional framework, and in turn, impairing the Coulombic efficiency and cycle performance of the secondary battery. Therefore, by controlling the thickness of the three-dimensional framework, the thickness of the first framework layer, the thickness of the second framework layer, the mass percent of the zero-dimensional material, and the mass ratio between the one-dimensional material and the two-dimensional material to fall within the above ranges, a lithiophilic gradient is favorably constructed in the three-dimensional framework, so as to favorably induce lithium metal to enter the interior of the three-dimensional framework and deposit from bottom upward, thereby reducing lithium dendrites and dead lithium generated, and improving the Coulombic efficiency and cycle performance of the secondary battery.

In some embodiments of this application, the negative electrode plate includes a metallic lithium layer. The second framework layer is located between the first framework layer and the metallic lithium layer. A thickness of the metallic lithium layer is 1 μm to 100 μm, and preferably 5 μm to 50 μm. For example, the thickness of the metallic lithium layer may be 1 μm, 20 μm, 40 μm, 60 μm, 80 μm, 100 μm, or a value falling within a range formed by any two thereof. By introducing the metallic lithium layer into the negative electrode plate and controlling the thickness of the metallic lithium layer to fall within the range specified herein, this application can compensate for the loss of lithium caused by irreversible reactions in the secondary battery during an initial charge, thereby improving the cycle performance of the secondary battery.

In some embodiments of this application, a particle diameter of the zero-dimensional material is 0.1 μm to 5 μm, and preferably 0.1 μm to 1 μm. For example, the particle diameter of the zero-dimensional material may be 0.1 μm, 1 μm, 2 μm, 3 μm, 4 μm, 5 μm, or a value falling within a range formed by any two thereof. By controlling the particle diameter of the zero-dimensional material to fall within the range specified herein, this application favorably induces the lithium metal to deposit, and improves the uniformity of the lithium metal deposition, thereby improving the Coulombic efficiency and cycle performance of the secondary battery.

In some embodiments of this application, a diameter of the one-dimensional material is 1 nm to 2000 nm, and a length-to-diameter ratio of the one-dimensional material is 0.1 to 20000. Preferably, the diameter of the one-dimensional material is 1 nm to 300 nm, and the length-to-diameter ratio of the one-dimensional material is 0.67 to 20000. More preferably, the diameter of the one-dimensional material is 1 nm to 50 nm, and the length-to-diameter ratio of the one-dimensional material is 5000 to 20000. For example, the diameter of the one-dimensional material is 1 nm, 1.5 nm, 2 nm, 2.5 nm, 3 nm, 5 nm, 10 nm, 50 nm, 100 nm, 250 nm, 500 nm, 1000 nm, 1500 nm, 2000 nm, or a value falling within a range formed by any two thereof. For example, the length-to-diameter ratio of the one-dimensional material may be 0.1, 0.67, 1, 1000, 2500, 5000, 6000, 7000, 7500, 8500, 9500, 10000, 12500, 13500, 14500, 15000, 17500, 20000, or a value falling within a range formed by any two thereof. By controlling the diameter and the length-to-diameter ratio of the one-dimensional material to fall within the range specified herein, the electron conduction is facilitated in the three-dimensional framework, thereby improving the Coulombic efficiency and cycle performance of the secondary battery.

In some embodiments of this application, a particle diameter of the zero-dimensional material is 0.1 μm to 5 μm; a diameter of the one-dimensional material is 0.001 μm to 2 μm, and the length-to-diameter ratio of the one-dimensional material is 0.1 to 20000. Preferably, the particle diameter of the zero-dimensional material is 0.1 μm to 1 μm; the diameter of the one-dimensional material is 0.001 μm to 0.3 μm, and the length-to-diameter ratio of the one-dimensional material is 0.67 to 20000. By controlling the particle diameter of the zero-dimensional material as well as the diameter and length-to-diameter ratio of the one-dimensional material to fall within the above ranges, the lithium metal is favorably induced to deposit, and the electron conduction is facilitated in the three-dimensional framework, thereby improving the Coulombic efficiency and cycle performance of the secondary battery.

In some embodiments of this application, the two-dimensional material includes titanium, carbon, and a surface group. The surface group includes at least one of —F, —O, or —OH. By selecting the above two-dimensional material, the lithium ion flow is favorably homogenized, thereby improving the homogeneity of the lithium metal deposition, and improving the Coulombic efficiency and cycle performance of the secondary battery.

In some embodiments of this application, an electrical conductivity a of the one-dimensional material satisfies: a≥1×10⁻⁶ S/cm, and an electrical conductivity b of the two-dimensional material satisfies: b≥2 S/cm, and b>a. Preferably, the electrical conductivity of the one-dimensional material satisfies: 1×10⁻⁶ S/cm≤a≤5000 S/cm, and the electrical conductivity of the two-dimensional material satisfies: 2 S/cm≤b≤50000 S/cm. For example, the electrical conductivity of the one-dimensional material may be 1×10⁻⁶ S/cm, 1×10⁻⁵ S/cm, 1×10⁻⁴ S/cm, 1×10⁻³ S/cm, 1×10⁻² S/cm, 1×10⁻¹ S/cm, 1 S/cm, 40 S/cm, 60 S/cm, 80 S/cm, 86 S/cm, 90 S/cm, 95 S/cm, 100 S/cm, 105 S/cm 150 S/cm, 200 S/cm, 300 S/cm, 400 S/cm, 500 S/cm, 2000 S/cm, 5000 S/cm, or a value falling within a range formed by any two thereof. For another example, the electrical conductivity of the two-dimensional material may be 2 S/cm, 5 S/cm, 50 S/cm, 150 S/cm, 300 S/cm, 450 S/cm, 500 S/cm, 600 S/cm, 700 S/cm, 750 S/cm, 800 S/cm, 850 S/cm, 900 S/cm, 1000 S/cm, 5000 S/cm, 50000 S/cm, or a value falling within a range formed by any two thereof. When the electrical conductivity of the one-dimensional material and the two-dimensional material falls within the above range, the one-dimensional material and the two-dimensional material are of good electron-conducting properties. At the same time, by controlling the values of a and b and the relationship between a and b to fall within the above ranges, the one-dimensional material can constitute a conductive network in the second framework layer to improve the electronic conductivity in the three-dimensional framework. Furthermore, the zero-dimensional material, the one-dimensional material, and the two-dimensional material are of different structures, and therefore, vary in electrical conductivity and lithiophilic properties. In this way, the three-dimensional framework exhibits an electronic conductivity gradient and a lithiophilic gradient, thereby further enabling the lithium metal to deposit from bottom upward. Therefore, the secondary battery according to this application achieves relatively high Coulombic efficiency and good cycle performance.

In some embodiments of this application, the one-dimensional conductive fibers include at least one of multi-walled carbon nanotubes (CNTs), carbon nanofibers (CNFs), silver wire, or nickel wire. The zero-dimensional material includes at least one of a metal material, an oxide, a nitride, a sulfide, or a carbide.

The metal material includes at least one of Ag, Au, Zn, or an alloy thereof. The oxide includes at least one of TiO₂, SiO₂, ZnO, SnO₂, Co₃O₄, or Fe₂O₃. The nitride includes Mo₂N₃ and/or Fe₆N₃. The sulfide includes MoS₂ and/or SnS₂. The carbide includes FeC. The one-dimensional material includes at least one of multi-walled carbon nanotubes, carbon nanofibers, a silver wire, or a nickel wire. The two-dimensional material includes MXene and/or graphene (Gr). The zero-dimensional material is a good lithiophilic material. The one-dimensional material and the two-dimensional material are good conductive materials, and possess good electron-conducting properties. By selecting the above one-dimensional conductive fibers, zero-dimensional material, one-dimensional material, and two-dimensional material, both an electronic conductivity gradient and a lithiophilic gradient are favorably constructed in the three-dimensional framework, thereby improving the electronic conductivity in the negative electrode plate, inducing the lithium metal to enter the interior of the three-dimensional framework and deposit from bottom upward, reducing lithium dendrites and dead lithium generated, and in turn, improving the Coulombic efficiency and cycle performance of the secondary battery. The diameter and the length-to-diameter ratio of the one-dimensional conductive fibers are not particularly limited herein, as long as the objectives of this application can be achieved. For example, the diameter of the one-dimensional conductive fibers is 0.001 μm to 2 μm, and the length-to-diameter ratio of the one-dimensional conductive fibers may be 0.1 to 20000.

In some embodiments of this application, a surface of the zero-dimensional material contains a wetting group. The wetting group includes at least one of —OH, —COOR, —COOH, —NH₂, or —SO₃H. The R in —COOR is at least one selected from methyl, ethyl, propyl, vinyl, or ethynyl. The wetting group induces the lithium metal to deposit, and improves the homogeneity of the lithium metal deposition, thereby improving the Coulombic efficiency and cycle performance of the secondary battery.

In some embodiments of this application, a porosity of the three-dimensional framework is greater than or equal to 80%. For example, the porosity of the three-dimensional framework may be 80%, 84%, 86%, 88%, 90%, 92%, or a value falling within a range formed by any two thereof. By controlling the porosity of the three-dimensional framework to fall within the above range, space is favorably provided for depositing the lithium metal, thereby improving the Coulombic efficiency and cycle performance of the secondary battery.

In some embodiments of this application, a thickness change rate of the three-dimensional framework is less than 10% when the lithium metal is deposited in the three-dimensional framework at a concentration of 5 μmAh/cm². For example, the thickness change rate of the three-dimensional framework may be 1%, 2%, 4%, 6%, 8%, 10%, or a value falling within a range formed by any two thereof. The thickness change rate falling within the above range indicates that the volume change of the three-dimensional framework is relatively small in the process of depositing lithium in the three-dimensional framework, thereby reducing the thickness expansion rate of the negative electrode plate, and in turn, achieving a lower thickness expansion rate of the secondary battery according to this application.

In some embodiments of this application, the metallic lithium layer is obtained by pre-supplementing of lithium. The pre-supplementing method of lithium is not particularly limited herein, as long as the objectives of this application can be achieved. As an example, a pre-supplementing method of lithium may include, but is not limited to: cold-pressing, hot-pressing, electrochemical supplementing of lithium, or lithium supplementing by physical vapor deposition (PVD).

In the application, the three-dimensional framework is prepared by suction-filtering. For example, a preparation method includes: first, adding a zero-dimensional material, a one-dimensional material, and a two-dimensional material into deionized water, and ultrasonically dispersing the materials until a homogeneous state to obtain a solution 1; subsequently, ultrasonically dispersing the one-dimensional conductive fibers in deionized water until a homogeneous state to obtain a solution 2; suction-filtering the solution 1 by using a suction-filtering device, adding the solution 2 for suction-filtering upon completion of the suction-filtration of the solution 1; drying the filtered product upon completion of the suction-filtration to obtain a film; and optionally, cold-pressing and laminating the film and the lithium metal to obtain a negative electrode plate. The suction-filtration device and the suction-filtration process are known in the art, and are not particularly limited herein. The solid content of the solution 1 and the solution 2 is not particularly limited herein, and may be selected according to the actual situation, as long as the objectives of this application can be achieved. The pressure applied in the cold-pressing and lamination process is not particularly limited herein, as long as the objectives of this application can be achieved. For example, the pressure applied in the cold-pressing and lamination may be 0.1 t to 3 t.

Generally, the solid content of the solution 1 may be adjusted by adjusting the volume of deionized water in the solution 1, and the thickness of the second framework layer may be adjusted by adjusting the solid content of the solution 1 or by adjusting the added volume and the filtering duration in suction-filtering the solution 1. For example, if the filtered volume and filtering duration of the solution 1 remain constant, the thickness of the second framework layer increases with the increase of the solid content of the solution 1; if the filtered volume and filtering duration of the solution 1 remain constant, the thickness of the second framework layer decreases with the decrease of the solid content of the solution 1. If the solid content of the solution 1 remains constant, the thickness of the second framework layer increases with the increase of the filtered volume and/or the decrease of the filtering duration of the solution 1; if the solid content of the solution 1 remains constant, the thickness of the second framework layer decreases with the decrease of the filtered volume and/or the increase of the filtering duration of the solution 1.

Generally, the solid content of the solution 2 may be adjusted by adjusting the volume of deionized water in the solution 2, and the thickness of the first framework layer may be adjusted by adjusting the solid content of the solution 2 or by adjusting the added volume and the filtering duration in suction-filtering the solution 2. For example, if the filtered volume and filtering duration of the solution 2 remain constant, the thickness of the first framework layer increases with the increase of the solid content of the solution 2; if the filtered volume and filtering duration of the solution 2 remain constant, the thickness of the first framework layer decreases with the decrease of the solid content of the solution 2. If the solid content of the solution 2 remains constant, the thickness of the first framework layer increases with the increase of the filtered volume and/or the decrease of the filtering duration of the solution 2; if the solid content of the solution 2 remains constant, the thickness of the first framework layer decreases with the decrease of the filtered volume and/or the increase of the filtering duration of the solution 2.

The thickness of the three-dimensional framework increases with the increase of the thickness of the first framework layer and/or the second framework layer, and decreases with the decrease of the thickness of the first framework layer and/or the second framework layer.

The zero-dimensional materials of different particle diameters and the one-dimensional materials of different diameters and different length-to-diameter ratios for use in this application are commercially available, and the sources of such materials are not particularly limited herein, as long as the objectives of this application can be achieved.

The secondary battery for use in this application is not particularly limited herein, and may include any device in which an electrochemical reaction occurs. The secondary batteries may include, but are not limited to, a lithium metal secondary battery, a lithium-ion secondary battery, a sodium-ion secondary battery, a lithium polymer secondary battery, and a lithium-ion polymer secondary battery.

The secondary battery in this application may further include a positive electrode plate. The positive electrode plate is not particularly limited herein, as long as the objectives of this application can be achieved.

For example, the positive electrode plate generally includes a positive current collector and a positive electrode material layer. The positive electrode material layer may be disposed on one surface of the positive current collector in a thickness direction or on both surfaces of the positive current collector in the thickness direction. It is hereby noted that the “surface” here may be the entire region of the positive current collector, or a partial region of the positive current collector, without being particularly limited herein, as long as the objectives of the application can be achieved. The positive current collector is not particularly limited herein, as long as the objectives of this application can be achieved. For example, the positive current collector may include, but is not limited to, an aluminum foil, an aluminum alloy foil, a composite current collector (such as an aluminum carbon composite current collector), or the like. The thickness of the positive current collector is not particularly limited herein, as long as the objectives of this application can be achieved. For example, the thickness is 8 μm to 20 μm.

In this application, the positive electrode material layer includes a positive electrode material. The positive electrode material is not particularly limited herein, as long as the objectives of this application can be achieved. For example, the positive electrode material may include at least one of a composite oxide of lithium or a composite oxide of a transition metal element. The transition metal element is not particularly limited herein, as long as the objectives of this application can be achieved. For example, the transition metal element may include at least one of nickel, manganese, cobalt, or iron. Specifically, the positive electrode material may include at least one of lithium nickel cobalt manganese oxide, lithium nickel cobalt aluminum oxide, lithium iron phosphate, a lithium-rich manganese-based material, lithium cobalt oxide, lithium manganese oxide, lithium manganese iron phosphate, or lithium titanium oxide.

In this application, the positive electrode material layer may further include a positive conductive agent. The positive conductive agent is not particularly limited herein, as long as the objectives of this application can be achieved. For example, the conductive agent may include, but is not limited to, at least one of conductive carbon black (Super P), carbon nanotubes (CNTs), carbon fibers, acetylene black, flake graphite, Ketjen black, graphene, a metal material, or a conductive polymer. The carbon nanotubes may include, but are not limited to, single-walled carbon nanotubes and/or multi-walled carbon nanotubes. The carbon fibers may include, but are not limited to, vapor grown carbon fibers (VGCF) and/or carbon nanofibers. The metal material may include, but is not limited to, metal powder and/or metal fibers. Specifically, the metal may include, but is not limited to, at least one of copper, nickel, aluminum, or silver. The conductive polymer may include, but is not limited to, at least one of polyphenylene derivatives, polyaniline, polythiophene, polyacetylene, or polypyrrole. In this application, the positive electrode material layer may further include a positive electrode binder. The positive electrode binder is not particularly limited herein, as long as the objectives of this application can be achieved. For example, the binder may include, but is not limited to, at least one of polyacrylic acid, polyacrylic acid sodium, polyacrylic acid potassium, polyacrylic acid lithium, polyimide, polyvinyl alcohol, carboxymethyl cellulose, sodium carboxymethyl cellulose, lithium carboxymethyl cellulose, polyamide imide, styrene butadiene rubber, or polyvinylidene difluoride.

Optionally, the positive electrode plate may further include a conductive layer. The conductive layer is located between the positive current collector and the positive electrode material layer. The constituents of the conductive layer are not particularly limited herein, and may be a conductive layer commonly used in the art. For example, the conductive layer may include, but is not limited to, the positive conductive agent and the positive electrode binder.

The secondary battery in this application further includes a separator. The separator is not particularly limited herein, and may be selected by a person skilled in the art as actually required, as long as the objectives of this application can be achieved. For example, the separator may be made of a material including but not limited to at least one of: a polyethylene (PE)- or polypropylene (PP)-based polyolefin (PO), a polyester (such as polyethylene terephthalate (PET)), cellulose, polyimide (PI), polyamide (PA), spandex, or aramid. The type of the separator may include, but is not limited to, at least one of a woven film, a non-woven film (non-woven fabric), a microporous film, a composite film, separator paper, a laminated film, or a spinning film. For example, the separator may include a substrate layer and a surface treatment layer. The substrate layer may be a non-woven fabric, film or composite film, which, in each case, is porous. The material of the substrate layer may include at least one of polyethylene, polypropylene, polyethylene terephthalate, polyimide, or the like. Optionally, the substrate layer may be a polypropylene porous film, a polyethylene porous film, a polypropylene non-woven fabric, a polyethylene non-woven fabric, or a polypropylene-polyethylene-polypropylene porous composite film. Optionally, the surface treatment layer is disposed on at least one surface of the substrate layer. The surface treatment layer may be a polymer layer or an inorganic compound layer, or a layer compounded of a polymer and an inorganic compound. For example, the inorganic compound layer includes inorganic particles and a binder. The inorganic particles are not particularly limited, and may include at least one of: aluminum oxide, silicon oxide, magnesium oxide, titanium oxide, hafnium dioxide, tin oxide, ceria, nickel oxide, zinc oxide, calcium oxide, zirconium oxide, yttrium oxide, silicon carbide, boehmite, aluminum hydroxide, magnesium hydroxide, calcium hydroxide, barium sulfate, or the like. The binder is not particularly limited, and may include at least one of polyvinylidene difluoride, poly(vinylidene difluoride-co-hexafluoropropylene), polyamide, polyacrylonitrile, polyacrylate, polyacrylic acid, polyacrylic acid sodium salt, polyvinylpyrrolidone, polyvinyl ether, poly methyl methacrylate, polytetrafluoroethylene, or polyhexafluoropropylene. The polymer layer includes a polymer, and the material of the polymer includes at least one of polyamide, polyacrylonitrile, acrylate polymer, polyacrylic acid, polyacrylate, polyvinylpyrrolidone, polyvinyl ether, polyvinylidene difluoride, poly(vinylidene fluoride-co-hexafluoropropylene), or the like.

The secondary battery in this application further includes an electrolyte solution. The electrolyte solution is not particularly limited herein, and may be selected by a person skilled in the art as actually required, as long as the objectives of this application can be achieved. For example, the electrolyte solution includes an organic solvent and a lithium salt. The types and content of the organic solvent and the lithium salt are not particularly limited herein, as long as the objectives of this application can be achieved. As an example, the organic solvent may include, but is not limited to, at least one of a carbonate compound, a carboxylate compound, an ether compound, or another organic solvent. The carbonate compound may include, but is not limited to, at least one of a chain carbonate compound, a cyclic carbonate compound, or a fluorocarbonate compound. The chain carbonate compound may include, but is not limited to, at least one of dimethyl carbonate (DMC), diethyl carbonate (DEC), dipropyl carbonate (DPC), methyl propyl carbonate (MPC), ethylene propyl carbonate (EPC), or ethyl methyl carbonate (EMC). The cyclic carbonate compound may include, but is not limited to, at least one of ethylene carbonate (EC), propylene carbonate (PC), butylene carbonate (BC), or vinyl ethylene carbonate (VEC). The fluorocarbonate compound may include, but is not limited to, at least one of fluoroethylene carbonate (FEC), 1,2-difluoroethylene carbonate, 1-difluoroethylene carbonate, 1,1,2-trifluoroethylene carbonate, 1,1,2,2-tetrafluoroethylene carbonate, fluoro-2-methyl ethylene carbonate, fluoro-methyl ethylene carbonate, 1,2-difluoro-methyl ethylene carbonate, 1,1,2-trifluoro-2-methyl ethylene carbonate, or trifluoromethyl ethylene carbonate. The carboxylate compound may include, but is not limited to, at least one of methyl formate, methyl acetate, ethyl acetate, n-propyl acetate, tert-butyl acetate, methyl propionate, ethyl propionate, propyl propionate, γ-butyrolactone, decanolactone, valerolactone, or caprolactone. The ether compound may include, but is not limited to, at least one of dibutyl ether, tetraglyme, diglyme, 1,2-dimethoxyethane, 1,2-diethoxyethane, ethoxy-methoxyethane, 2-methyltetrahydrofuran, or tetrahydrofuran. The other organic solvent may include, but is not limited to, at least one of dimethyl sulfoxide, 1,2-dioxolane, sulfolane, methyl sulfolane, 1,3-dimethyl-2-imidazolidinone, N-methyl-2-pyrrolidone, dimethylformamide, acetonitrile, trimethyl phosphate, triethyl phosphate, or trioctyl phosphate. As an example, the lithium salt may include, but is not limited to, at least one of LiTFSI, LiPF₆, LiBF₄, LiAsF₆, LiClO₄, LiB(C₆H₅)₄, LiCH₃SO₃, LiCF₃SO₃, LiC(SO₂CF₃)₃, Li₂SiF₆, lithium bis(oxalato)borate (LiBOB), or lithium difluoroborate.

The process of preparing the secondary battery in this application is well known to a person skilled in the art, and is not particularly limited herein. For example, the preparation process may include, but is not limited to, the following steps: stacking the positive electrode plate, the separator, and the negative electrode plate in sequence, and performing operations such as winding and folding as required to obtain a jelly-roll electrode assembly; putting the electrode assembly into a package, injecting the electrolyte solution into the package, and sealing the package to obtain a secondary battery; or, stacking the positive electrode plate, the separator, and the negative electrode plate in sequence, and then fixing the four corners of the entire stacked structure by use of adhesive tape to obtain a stacked-type electrode assembly, putting the electrode assembly into a package, injecting the electrolyte solution into the package, and sealing the package to obtain a secondary battery. In addition, an overcurrent prevention element, a guide plate, and the like may be placed into a pocket as required, so as to prevent the rise of internal pressure, overcharge, and overdischarge of the secondary battery. The pocket is a pocket known in the art, and is not limited herein.

A second aspect of this application provides an electronic device. The electronic device includes the secondary battery disclosed in any one of the preceding embodiments. The electronic device is not particularly limited herein, and may be any electronic device well-known in the prior art. For example, the electronic device may include, but is not limited to, a notebook computer, pen-inputting computer, mobile computer, e-book player, portable phone, portable fax machine, portable photocopier, portable printer, stereo headset, video recorder, liquid crystal display television set, handheld cleaner, portable CD player, mini CD-ROM, transceiver, electronic notepad, calculator, memory card, portable voice recorder, radio, backup power supply, motor, automobile, motorcycle, power-assisted bicycle, bicycle, lighting appliance, toy, game console, watch, electric tool, flashlight, camera, large household storage battery, or lithium-ion capacitor.

### EMBODIMENTS

The implementations of this application are described below in more detail with reference to embodiments and comparative embodiments. Various tests and evaluations are performed by the following methods.

### Test Methods and Devices

### Testing the Coulombic Efficiency

Putting a lithium metal battery into a 20° C. thermostat, and leaving the battery to stand for 30 μminutes so that the temperature of the lithium metal battery becomes constant. Charging the lithium metal battery at a constant current of 0.2 C until the voltage reaches 3.7 V, and then charging the battery at a constant voltage of 3.7 V until the current drops to 0.025 C, and leaving the battery to stand for 5 μminutes. Subsequently, discharging the battery at a constant current of 0.2 C until the voltage drops to 2.8 V, and leaving the battery to stand for 5 μminutes, thereby completing one charge-discharge cycle. Letting the first-cycle discharge capacity be 100%. Repeating the charge-discharge cycle until the discharge capacity fades to 80%. Stopping the test, calculating a ratio between the discharge capacity and the charge capacity in each cycle, and averaging out the ratios in all the cycles to obtain the Coulombic efficiency.

### Testing the Cycle Performance

Putting a lithium metal battery into a 25° C.±2° C. thermostat, and leaving the battery to stand for 2 hours so that the temperature of the lithium-ion battery becomes constant. The cycling process 1 is: Charging the lithium metal battery at a constant current of 0.2 C until the voltage reaches 3.7 V, and then charging the battery at a constant voltage of 3.7 V until the current drops to 0.5 C, and leaving the battery to stand for 5 μminutes; subsequently, discharging the battery at a constant current of 1 C until the voltage drops to 2.8V, thereby completing one charge-discharge cycle. Recording a discharge capacity of the lithium metal battery in the first cycle; afterward, iterating the foregoing cycling process 1, and recording the discharge capacity at the end of each cycle. Performing a cycling process 2 to complete one charge-discharge cycle when the iteration proceeds to the 50^{th} cycle, 100^{th} cycle, 150^{th} cycle, 200^{th} cycle, 250^{th} cycle separately. The cycling process 2 is: charging the lithium metal battery at a constant current of 0.05 C until the voltage reaches 3.7 V, and then charging the battery at a constant voltage of 3.7 V until the current drops to 0.025 C, and leaving the battery to stand for 5 μminutes; and then discharging the battery at a constant current of 0.05 C until the voltage drops to 2.8 V, thereby completing one charge-discharge cycle. Recording the discharge capacity at the end of each cycle.

Cycle capacity retention rate of a lithium metal battery=(discharge capacity at the end of each cycle/discharge capacity at the end of the first cycle)×100%.

Recording the number of cycles when the cycle capacity retention rate of the lithium metal battery drops to 80%. Testing 10 lithium metal batteries for each embodiment and each comparative embodiment, and averaging out the numbers of cycles to obtain a final result.

### Testing the Porosity

Cutting the three-dimensional framework prepared in each embodiment and each comparative embodiment into circular pieces of 10 mm in diameter that serve as specimens. Ensuring that the surface of each specimen is flat without notches. Obtaining a true volume V₁ of the circular piece by using a true density tester, calculating the apparent volume as: V₂=S×H (S is a surface area of the specimen, and H is the thickness of the specimen), and calculating the porosity as: porosity=(V₂−V₁)/V₂×100%.

In this test method, the true volume is defined as a volume of a specimen net of pores. The porosity is defined as a ratio of the pore volume of a specimen to the apparent volume of the specimen, and reflects the magnitude of pores in the specimen. The porosity is essential to ion transport in a lithium metal battery.

### Scanning Electron Microscope (SEM) Test

Performing the SEM test by using a Philips XL-30 field emission scanning electron microscope.

### Method for Measuring the Thicknesses of a Three-Dimensional Framework, a First Framework Layer, and a Second Framework Layer

Suction-filtering a solution 1 by using a suction-filtering device, adding a solution 2 for suction-filtering upon completion of the suction-filtration of the solution 1, drying the filtered product upon completion of the suction-filtration to obtain a film, and measuring the thickness of the film with a micrometer, denoted as H₀; suction-filtering the solution 1 by using the suction-filtering device, drying the filtered product upon completion of the suction-filtration to obtain a film 1, and measuring the thickness of the film 1 with a micrometer, denoted as H₁. The thickness of the three-dimensional framework is H₀, the thickness of the first framework layer is H₀-H₁, and the thickness of the second framework layer is H₁. The solution 1 and solution 2 are the solution 1 and solution 2 in each embodiment or each comparative embodiment.

### Testing the Thickness Change Rate

Cutting a prepared three-dimensional framework to obtain a cross-section. Capturing an image of the cross-section by using a Philips XL-30 field emission scanning electron microscope, so as to obtain a scanning electron microscope (SEM) image of the cross-section of the three-dimensional framework. Importing the SEM image into the Nano Measurer software to obtain a thickness of the three-dimensional framework, denoted as H₂.

Discharging a lithium metal battery in each embodiment or each comparative embodiment at a current density of 0.2 μmA/cm² for a duration of T₀ hour, so that the concentration of deposited lithium metal is 5 mAh/cm². Disassembling the lithium metal battery, cleaning the electrode plate by use of DME and then cutting the electrode plate to obtain a cross-section. Capturing an image of the cross-section of the three-dimensional framework in the electrode plate by using a Philips XL-30 field emission scanning electron microscope, so as to obtain a SEM image of the cross-section of the three-dimensional framework in the electrode plate. Importing the SEM image into the Nano Measurer software to obtain a thickness of the three-dimensional framework in the electrode plate, denoted as H₃. In Embodiments 1 to 24 and Comparative Embodiments 1 to 10, To is 25 h.

$$Thickness change rate = ( {H}_{3} - {H}_{2} ) / {H}_{2} \times 100 \% .$$

### Testing the Electrical Conductivity

Testing the electrical conductivity in accordance with the national standard Test Method of Electrical Conductivity Analyzer (GB11007-89).

### Embodiment 1

### <Preparing a Negative Electrode Plate>

Adding 7 mg (m₁) of multi-walled carbon nanotubes (manufacturer: Aladdin, designation: 308068-56-6) as one-dimensional material and 1 mg (m₂) of MXene (manufacturer: Nanjing XFNANO Materials Tech Co., Ltd., designation: 12363-89-2) as a two-dimensional material into 100 mL of deionized water, and ultrasonically dispersing the mixture thoroughly. Adding 0.16 mg (m₀) of tin dioxide particles as a zero-dimensional material, and continuing to sonicate the mixture until the particles are dispersed homogeneously, so as to obtain a solution 1. The particle diameter of the zero-dimensional material is 0.3 μm. The diameter of the one-dimensional material is 2 nm, and the length-to-diameter ratio of the one-dimensional material is 10000 to 12000.

Dispersing 1 mg of multi-walled carbon nanotubes (manufacturer: Aladdin, designation: 308068-56-6) as one-dimensional conductive fibers ultrasonically in 20 mL of deionized water until a homogeneous state to obtain a solution 2.

Suction-filtering 100 mL (A₁) of the solution 1 by use of a suction-filtering device for a duration (t₁) of 180 μminutes, adding 20 mL (A₂) of the solution 2 upon completion of the suction-filtration of the solution 1, and continuing to suction-filter for a duration (t₂) of 30 μminutes, and then putting the filtered product into an 80° C. oven to dry for 24 hours to obtain a film. Cold-pressing and laminating the film with a 20 μm-thick lithium metal sheet to obtain a negative electrode plate. The thickness of the first framework layer is 5 μm, the thickness of the second framework layer is 50 μm, the thickness of the three-dimensional framework is 55 μm, and the cold-pressing pressure is 0.2 t. Subsequently, die-cutting the negative electrode plate into φ18 mm circular pieces for future use.

### <Preparing a Positive Electrode Plate>

Mixing lithium iron phosphate (LiFePO₄) as a positive active material, conductive carbon black (Super P), and polyvinylidene difluoride (PVDF) at a mass ratio of 97.5:1.0:1.5, adding N-methyl-pyrrolidone (NMP) as a solvent to form a slurry with a solid content of 75 wt %, and stirring well. Applying the slurry evenly onto one surface of a 10 μm-thick positive current collector aluminum foil, and oven-drying the slurry at 90° C. to obtain a positive electrode plate with a single side coated with a positive electrode material layer of 50 μm in thickness. Subsequently, repeating the above steps on the other surface of the positive electrode plate to obtain a positive electrode plate coated with the positive electrode material layer on both sides. Subsequently, cold-pressing and cutting the positive electrode plate into φ14 mm circular pieces for future use.

### <Preparing an Electrolyte Solution>

Mixing dioxolane (DOL) and dimethyl ether (DME) at a volume ratio of DOL:DME=1:1 in a dry argon atmosphere to obtain an organic solvent, adding a lithium salt LiTFSI into the organic solvent, dissolving the lithium salt, and stirring well to obtain an electrolyte solution. The concentration of the lithium salt in the electrolyte solution is 1 μmol/L.

### <Separator>

Using a 15 M-thick polyethylene (PE) film (manufactured by Celgard) as a separator.

### <Preparing a Lithium Metal Battery>

Leaving an opening of a positive electrode shell of a button battery shell to face upward in a vacuum glovebox, putting a gasket and the above-prepared positive electrode plate into the glovebox in sequence, and adding an electrolyte solution dropwise to infiltrate the surface of the positive electrode plate.

Subsequently, stacking the separator onto the positive electrode plate, and adding the electrolyte solution dropwise onto the separator. Stacking the above-prepared negative electrode plate, the gasket, and a contact spring onto the separator in sequence after the surface of the separator is wetted by the electrolyte solution. Afterward, fastening the negative electrode shell of the button battery shell, sealing the shell by use of a sealing machine, and pressing the sealed structure to obtain a button battery. The gasket and the contact spring are commercially available, and are not limited herein.

### Embodiment 2

The operations are the same as those in Embodiment 1 except: in preparing the negative electrode plate, in the solution 1, the mass m₁ of the multi-walled carbon nanotubes as a one-dimensional material is 10.5 mg, the mass m₂ of the MXene as a two-dimensional material is 1.5 mg, the mass m₀ of the tin dioxide particles as a zero-dimensional material is 0.24 mg, and the volume of the deionized water is 150 mL; in the solution 2, the mass of the multi-walled carbon nanotubes as one-dimensional conductive fibers is 1.5 mg, and the volume of the deionized water is 30 mL; the amount A₁ of the solution 1 added during suction-filtration is 150 mL, the filtering duration t₁ is 288 μmin, the amount A₂ of the solution 2 added is 20 mL, and the diameter of the one-dimensional material and the length-to-diameter ratio of the one-dimensional material are adjusted in accordance with Table 1.

### Embodiment 3

The operations are the same as those in Embodiment 1 except: in preparing the negative electrode plate, in the solution 1, the mass m₁ of the multi-walled carbon nanotubes as a one-dimensional material is 14 mg, the mass m₂ of the MXene as a two-dimensional material is 2 mg, the mass m₀ of the tin dioxide particles as a zero-dimensional material is 0.32 mg, and the volume of the deionized water is 200 mL; in the solution 2, the mass of the multi-walled carbon nanotubes as one-dimensional conductive fibers is 2 mg, and the volume of the deionized water is 40 mL; the amount A₁ of the solution 1 added during suction-filtration is 200 mL, the filtering duration t₁ is 360 μmin, the amount A₂ of the solution 2 added is 20 mL, and the diameter of the one-dimensional material and the length-to-diameter ratio of the one-dimensional material are adjusted in accordance with Table 1.

### Embodiment 4

The operations are the same as those in Embodiment 1 except: in preparing the negative electrode plate, the amount A₁ of the solution 1 added during suction-filtration is 20 mL, the filtering duration t₁ is 36 μmin, and the diameter of the one-dimensional material and the length-to-diameter ratio of the one-dimensional material are adjusted in accordance with Table 1.

### Embodiment 5

The operations are the same as those in Embodiment 1 except: in preparing the negative electrode plate, in the solution 1, the mass m₁ of the multi-walled carbon nanotubes as a one-dimensional material is 28 mg, the mass m₂ of the MXene as a two-dimensional material is 4 mg, the m₁ of the tin dioxide particles as a zero-dimensional material is 0.64 mg, and the volume of the deionized water is 400 mL; during suction-filtration, only the solution 1 is suction-filtered, and the solution 2 is not suction-filtered; the amount A₁ of the solution 1 added is 400 mL, and the filtering duration t₁ is 720 μmin; and the diameter of the one-dimensional material and the length-to-diameter ratio of the one-dimensional material are adjusted in accordance with Table 1.

### Embodiment 6

The operations are the same as those in Embodiment 1 except: in preparing the negative electrode plate, in the solution 1, the mass m₁ of the multi-walled carbon nanotubes as a one-dimensional material is 14 mg, the mass m₂ of the MXene as a two-dimensional material is 2 mg, the mass m₀ of the tin dioxide particles as a zero-dimensional material is 0.32 mg, and the volume of the deionized water is 200 mL; the amount A₁ of the solution 1 added during suction-filtration is 108 mL, the filtering duration t₁ is 200 μmin, the amount A₂ of the solution 2 added is 4 mL, the filtering duration t₂ is 10 μmin, and the diameter of the one-dimensional material and the length-to-diameter ratio of the one-dimensional material are adjusted in accordance with Table 1.

### Embodiment 7

The operations are the same as those in Embodiment 1 except: in preparing the negative electrode plate, in the solution 1, the mass m₁ of the multi-walled carbon nanotubes as a one-dimensional material is 14 mg, the mass m₂ of the MXene as a two-dimensional material is 2 mg, the mass m₀ of the tin dioxide particles as a zero-dimensional material is 0.32 mg, and the volume of the deionized water is 200 mL; the amount A₁ of the solution 1 added during suction-filtration is 104 mL, the filtering duration t₁ is 188 μmin, the amount A₂ of the solution 2 added is 12 mL, the filtering duration t₂ is 18 μmin, and the diameter of the one-dimensional material and the length-to-diameter ratio of the one-dimensional material are adjusted in accordance with Table 1.

### Embodiment 8

The operations are the same as those in Embodiment 1 except: in preparing the negative electrode plate, in the solution 2, the mass of the multi-walled carbon nanotubes as one-dimensional conductive fibers is 2 mg, and the volume of the deionized water is 40 mL; the amount A₁ of the solution 1 added during suction-filtration is 80 mL, the filtering duration t₁ is 168 μmin, the amount A₂ of the solution 2 added is 40 mL, the filtering duration t₂ is 60 μmin, and the diameter of the one-dimensional material and the length-to-diameter ratio of the one-dimensional material are adjusted in accordance with Table 1.

### Embodiment 9

The operations are the same as those in Embodiment 1 except: in preparing the negative electrode plate, in the solution 1, the mass m₁ of the multi-walled carbon nanotubes as a one-dimensional material is 16 mg, the mass m₂ of the MXene as a two-dimensional material is 2 mg, the mass m₀ of the tin dioxide particles as a zero-dimensional material is 0.36 mg, and the volume of the deionized water is 200 mL; the amount A₁ of the solution 1 added during suction-filtration is 115 mL, the filtering duration t₁ is 198 μmin, no solution 2 is added, and the diameter of the one-dimensional material and the length-to-diameter ratio of the one-dimensional material are adjusted in accordance with Table 1.

### Embodiment 10

The operations are the same as those in Embodiment 1 except: in preparing the negative electrode plate, the mass m₀ of the tin dioxide particles as a zero-dimensional material in the solution 1 is 0.08 mg, and the filtering duration t₁ of the solution 1 is 180 μmin during suction-filtration, and the diameter of the one-dimensional material and the length-to-diameter ratio of the one-dimensional material are adjusted in accordance with Table 1.

### Embodiment 11

The operations are the same as those in Embodiment 1 except: in preparing the negative electrode plate, the mass m₀ of the tin dioxide particles as a zero-dimensional material in the solution 1 is 0.4 mg, and the filtering duration t₁ of the solution 1 is 180 μmin during suction-filtration, and the diameter of the one-dimensional material and the length-to-diameter ratio of the one-dimensional material are adjusted in accordance with Table 1.

### Embodiment 12

The operations are the same as those in Embodiment 1 except: in preparing the negative electrode plate, the mass m₀ of the tin dioxide particles as a zero-dimensional material in the solution 1 is 0.8 mg, and the filtering duration t₁ of the solution 1 is 180 μmin during suction-filtration, and the length-to-diameter ratio of the one-dimensional material is adjusted in accordance with Table 1.

### Embodiment 13

The operations are the same as those in Embodiment 1 except: in preparing the negative electrode plate, the mass m₀ of the tin dioxide particles as a zero-dimensional material in the solution 1 is 2.7 mg, and the filtering duration t₁ of the solution 1 is 180 μmin during suction-filtration.

### Embodiment 14

The operations are the same as those in Embodiment 1 except: in preparing the negative electrode plate, in the solution 1, the mass m₁ of the multi-walled carbon nanotubes as a one-dimensional material is 7.57 mg, the mass m₂ of the MXene as a two-dimensional material is 0.43 mg, and the diameter of the one-dimensional material and the length-to-diameter ratio of the one-dimensional material are adjusted in accordance with Table 1.

### Embodiment 15

The operations are the same as those in Embodiment 1 except: in preparing the negative electrode plate, in the solution 1, the mass m₁ of the multi-walled carbon nanotubes as a one-dimensional material is 2 mg, the mass m₂ of the MXene as a two-dimensional material is 6 mg, and the diameter of the one-dimensional material and the length-to-diameter ratio of the one-dimensional material are adjusted in accordance with Table 1.

### Embodiment 16

The operations are the same as those in Embodiment 1 except: in preparing the negative electrode plate, in the solution 1, the mass m₁ of the multi-walled carbon nanotubes as a one-dimensional material is 1 mg, the mass m₂ of the MXene as a two-dimensional material is 7 mg, and the diameter of the one-dimensional material and the length-to-diameter ratio of the one-dimensional material are adjusted in accordance with Table 1.

### Embodiment 17

The operations are the same as those in Embodiment 1 except: in preparing the negative electrode plate, both the one-dimensional material in the solution 1 and the one-dimensional conductive fibers in the solution 2 are carbon nanofibers (manufacturer: Nanjing XFNANO Materials Tech Co., Ltd., designation: 1333-86-4), and the diameter of the one-dimensional material and the length-to-diameter ratio of the one-dimensional material are adjusted in accordance with Table 1.

### Embodiment 18

The operations are the same as those in Embodiment 1 except: in preparing the negative electrode plate, the two-dimensional material in the solution 1 is graphene (manufacturer: Nanjing XFNANO Materials Tech Co., Ltd., designation: 7440-44-0), and the diameter of the one-dimensional material and the length-to-diameter ratio of the one-dimensional material are adjusted in accordance with Table 1.

### Embodiment 19

The operations are the same as those in Embodiment 1 except: in preparing the negative electrode plate, the zero-dimensional material in the solution 1 is SiO₂, and the diameter of the one-dimensional material and the length-to-diameter ratio of the one-dimensional material are adjusted in accordance with Table 1.

### Embodiment 20

The operations are the same as those in Embodiment 1 except: in preparing the negative electrode plate, the zero-dimensional material in the solution 1 is TiO₂, and the diameter of the one-dimensional material and the length-to-diameter ratio of the one-dimensional material are adjusted in accordance with Table 1.

### Embodiment 21

The operations are the same as those in Embodiment 1 except: in preparing the negative electrode plate, the zero-dimensional material in the solution 1 is Ag powder (manufacturer: Aladdin, designation: 7440-22-4), the particle diameter of the Ag powder is 0.1 μm to 1 μm, and the diameter of the one-dimensional material and the length-to-diameter ratio of the one-dimensional material are adjusted in accordance with Table 1.

### Embodiments 22 to 24

The operations are the same as those in Embodiment 1 except: in preparing the negative electrode plate, the film is cold-rolled after being dried, and the diameter of the one-dimensional material and the length-to-diameter ratio of the one-dimensional material are adjusted in accordance with Table 1. The pressures applied in the cold-rolling in the three embodiments are 0.8 t, 1.2 t, and 1.5 t, respectively.

### Embodiment 25

<Preparing Modified Fe₆N_{3>}

Sintering Fe₆N₃ at 500° C. for 2 hours in an NH₃ atmosphere to obtain Fe₆N₃ containing a wetting group —NH₂ on the surface, that is, modified Fe₆N₃.

The operations are the same as those in Embodiment 1 except: in preparing the negative electrode plate, the zero-dimensional material in the solution 1 is modified Fe₆N₃, and the diameter of the one-dimensional material and the length-to-diameter ratio of the one-dimensional material are adjusted in accordance with Table 1.

### Comparative Embodiment 1

The operations are the same as those in Embodiment 1 except: in preparing the negative electrode plate, only multi-walled carbon nanotubes are added as a one-dimensional material into the solution 1 in an amount (m₁) of 10 mg; during suction-filtration, only the solution 1 is suction-filtered, and the solution 2 is not suction-filtered; the amount A₁ of the solution 1 added is 100 mL, the filtering duration t₁ is 198 μmin, and the diameter of the one-dimensional material and the length-to-diameter ratio of the one-dimensional material are adjusted in accordance with Table 1.

### Comparative Embodiment 2

The operations are the same as those in Embodiment 1 except: in preparing the negative electrode plate, in the solution 1, multi-walled carbon nanotubes are added as a one-dimensional material in an amount (m₁) of 10 mg, and tin dioxide particles are added as a zero-dimensional material in an amount (m₀) of 0.2 mg; during suction-filtration, only the solution 1 is suction-filtered, and the solution 2 is not suction-filtered; the amount A₁ of the solution 1 added is 100 mL, the filtering duration t₁ is 198 μmin, and the diameter of the one-dimensional material and the length-to-diameter ratio of the one-dimensional material are adjusted in accordance with Table 1.

### Comparative Embodiment 3

The operations are the same as those in Embodiment 1 except: in preparing the negative electrode plate, only the Mxene is added as a two-dimensional material into the solution 1 in an amount (m₂) of 10 mg; during suction-filtration, only the solution 1 is suction-filtered, and the solution 2 is not suction-filtered, the amount A₁ of the solution 1 added is 100 mL, and the filtering duration t₁ is 198 μmin.

### Comparative Embodiment 4

The operations are the same as those in Embodiment 1 except that a purchased 50 μm-thick pre-lithiated lithium-copper composite strip is used as a negative electrode plate.

### Comparative Embodiment 5

The operations are the same as those in Embodiment 1 except: in preparing the negative electrode plate, in the solution 1, the mass m₁ of the multi-walled carbon nanotubes as a one-dimensional material is 4.61 mg, the mass m₂ of the MXene as a two-dimensional material is 0.66 mg, the mass m₀ of the tin dioxide particles as a zero-dimensional material is 2.89 mg, and the diameter of the one-dimensional material and the length-to-diameter ratio of the one-dimensional material are adjusted in accordance with Table 1.

### Comparative Embodiment 6

The operations are the same as those in Embodiment 1 except: in preparing the negative electrode plate, in the solution 1, the mass m₁ of the multi-walled carbon nanotubes as a one-dimensional material is 7.69 mg, the mass m₂ of the MXene as a two-dimensional material is 0.31 mg, the mass m₀ of the tin dioxide particles as a zero-dimensional material is 0.16 mg, and the diameter of the one-dimensional material and the length-to-diameter ratio of the one-dimensional material are adjusted in accordance with Table 1.

### Comparative Embodiment 7

The operations are the same as those in Embodiment 1 except: the amount A₁ of the solution 1 added during suction-filtration is 10 mL, the filtering duration t₁ is 180 μmin, and the diameter of the one-dimensional material and the length-to-diameter ratio of the one-dimensional material are adjusted in accordance with Table 1.

### Comparative Embodiment 8

The operations are the same as those in Embodiment 1 except: in preparing the negative electrode plate, in the solution 1, the mass m₁ of the multi-walled carbon nanotubes as a one-dimensional material is 35 mg, the mass m₂ of the MXene as a two-dimensional material is 5 mg, the mass m₀ of the tin dioxide particles as a zero-dimensional material is 0.8 mg, and the volume of the deionized water is 500 mL; the amount A₁ of the solution 1 added during suction-filtration is 500 mL, the filtering duration t₁ is 180 μmin, and the diameter of the one-dimensional material and the length-to-diameter ratio of the one-dimensional material are adjusted in accordance with Table 1.

### Comparative Embodiment 9

The operations are the same as those in Embodiment 1 except: in preparing the negative electrode plate, in the solution 1, the mass m₁ of the multi-walled carbon nanotubes as a one-dimensional material is 23.2 mg, the mass m₂ of the MXene as a two-dimensional material is 3.32 mg, the mass m₀ of the tin dioxide particles as a zero-dimensional material is 14.28 mg, and the volume of the deionized water is 500 mL; the amount A₁ of the solution 1 added during suction-filtration is 500 mL, the filtering duration t₁ is 180 μmin, and the diameter of the one-dimensional material and the length-to-diameter ratio of the one-dimensional material are adjusted in accordance with Table 1.

### Comparative Embodiment 10

The operations are the same as those in Embodiment 1 except: in preparing the negative electrode plate, in the solution 1, the mass m₁ of the multi-walled carbon nanotubes as a one-dimensional material is 25.5 mg, the mass m₂ of the MXene as a two-dimensional material is 1.02 mg, the mass m₀ of the tin dioxide particles as a zero-dimensional material is 14.28 mg, and the volume of the deionized water is 500 mL; the amount A₁ of the solution 1 added during suction-filtration is 500 mL, the filtering duration t₁ is 180 μmin, and the diameter of the one-dimensional material and the length-to-diameter ratio of the one-dimensional material are adjusted in accordance with Table 1.

Table 1 shows the preparation parameters and performance test results of each embodiment and comparative embodiment.

TABLE 1

| | | Thickness | | | | | | | |
|---|---|---|---|---|---|---|---|---|---|
| | | of first | | | | | | | |
| | One-dimensional | framework | | | | | | | |
| | conductive | layer | A₂ | T₂ | Zero-dimensional | m₀ | One-dimensional | m₁ | Two-dimensional |
| | fibers | (μm) | (mL) | (min) | material | (mg) | material | (mg) | material |
| Embodiment 1 | CNT | 5 | 20 | 30 | SnO₂ | 0.16 | CNT | 7 | MXene |
| Embodiment 2 | CNT | 5 | 20 | 30 | SnO₂ | 0.24 | CNT | 11 | MXene |
| Embodiment 3 | CNT | 5 | 20 | 30 | SnO₂ | 0.32 | CNT | 14 | MXene |
| Embodiment 4 | CNT | 5 | 20 | 30 | SnO₂ | 0.16 | CNT | 7 | MXene |
| Embodiment 5 | CNT | 0 | / | / | SnO₂ | 0.64 | CNT | 28 | MXene |
| Embodiment 6 | CNT | 1 | 4 | 5 | SnO₂ | 0.32 | CNT | 14 | MXene |
| Embodiment 7 | CNT | 3 | 12 | 18 | SnO₂ | 0.32 | CNT | 14 | MXene |
| Embodiment 8 | CNT | 10 | 40 | 60 | SnO₂ | 0.16 | CNT | 7 | MXene |
| Embodiment 9 | / | 0 | / | / | SnO₂ | 0.36 | CNT | 16 | MXene |
| Embodiment 10 | CNT | 5 | 20 | 30 | SnO₂ | 0.08 | CNT | 7 | MXene |
| Embodiment 11 | CNT | 5 | 20 | 30 | SnO₂ | 0.4 | CNT | 7 | MXene |
| Embodiment 12 | CNT | 5 | 20 | 30 | SnO₂ | 0.8 | CNT | 7 | MXene |
| Embodiment 13 | CNT | 5 | 20 | 30 | SnO₂ | 2.7 | CNT | 7 | MXene |
| Embodiment 14 | CNT | 5 | 20 | 30 | SnO₂ | 0.16 | CNT | 7.6 | MXene |
| Embodiment 15 | CNT | 5 | 20 | 30 | SnO₂ | 0.16 | CNT | 7.6 | MXene |
| Embodiment 16 | CNT | 5 | 20 | 30 | SnO₂ | 0.16 | CNT | 1 | MXene |
| Embodiment 17 | CNFs | 5 | 20 | 30 | SnO₂ | 0.16 | CNFs | 7 | MXene |
| Embodiment 18 | CNT | 5 | 20 | 30 | SnO₂ | 0.16 | CNT | 7 | Gr |
| Embodiment 19 | CNT | 5 | 20 | 20 | SiO₂ | 0.16 | CNT | 7 | MXene |
| Embodiment 20 | CNT | 5 | 20 | 30 | TiO₂ | 0.16 | CNT | 7 | MXene |
| Embodiment 21 | CNT | 5 | 20 | 30 | Ag | 0.16 | CNT | 7 | MXene |
| Embodiment 22 | CNT | 5 | 20 | 30 | SnO₂ | 0.16 | CNT | 7 | MXene |
| Embodiment 23 | CNT | 5 | 20 | 30 | SnO₂ | 0.16 | CNT | 7 | MXene |
| Embodiment 24 | CNT | 5 | 20 | 30 | SnO₂ | 0.16 | CNT | 7 | XMene |
| Embodiment 25 | CNT | 5 | 20 | 30 | Modified | 0.16 | CNT | 7 | MXene |
| | | | | | Fe₆N₃ | | | | |
| Comparative | / | / | / | / | / | / | CNT | 10 | / |
| Embodiment 1 | | | | | | | | | |
| Comparative | / | / | / | | SnO₂ | 0.2 | CNT | 10 | / |
| Embodiment 2 | | | | | | | | | |
| Comparative | / | / | / | | / | / | / | / | MXene |
| Embodiment 3 | | | | | | | | | |
| Comparative | / | / | / | | LiCu | / | / | / | / |
| Embodiment 4 | | | | | | | | | |
| Comparative | CNT | 5 | 20 | 30 | SnO₂ | 2.89 | CNT | 4.6 | MXene |
| Embodiment 5 | | | | | | | | | |
| Comparative | CNT | 5 | 20 | 30 | SnO₂ | 0.16 | CNT | 7.7 | MXene |
| Embodiment 6 | | | | | | | | | |
| Comparative | CNT | 5 | 20 | 30 | SnO₂ | 0.16 | CNT | 7 | MXene |
| Embodiment 7 | | | | | | | | | |
| Comparative | CNT | 5 | 20 | 30 | SnO₂ | 0.8 | CNT | 35 | MXene |
| Embodiment 8 | | | | | | | | | |
| Comparative | CNT | 5 | 20 | 30 | SnO₂ | 14.3 | CNT | 23 | MXene |
| Embodiment 9 | | | | | | | | | |
| Comparative | CNT | 5 | 20 | 30 | SnO₂ | 14.3 | CNT | 26 | MXene |
| Embodiment 10 | | | | | | | | | |

| | | | | | | | | Particle | |
|---|---|---|---|---|---|---|---|---|---|
| | | Thickness | | | Thickness | | Mass percent | diameter | |
| | | of second | | | of three- | Mass ratio | of zero- | of zero- | Diameter of |
| | | framework | | | dimensional | between one- | dimensional | dimensional | one-dimensional |
| | m₂ | layer | A₁ | T₁ | framework | dimensional | material | material | material |
| | (mg) | (μm) | (mL) | (min) | (μm) | and two- [symbol] | (%) | (μm) | (nm) |
| Embodiment 1 | 1 | 50 | 100 | 180 | 55 | 7:01 | 2 | 0 | 2 |
| Embodiment 2 | 1.5 | 80 | 150 | 288 | 85 | 7:01 | 2 | 0 | 3 |
| Embodiment 3 | 2 | 100 | 200 | 360 | 125 | 7:01 | 2 | 0 | 3 |
| Embodiment 4 | 1 | 10 | 20 | 36 | 15 | 7:01 | 2 | 0 | 2 |
| Embodiment 5 | 4 | 200 | 400 | 720 | 200 | 7:01 | 2 | 0 | 2 |
| Embodiment 6 | 2 | 54 | 108 | 200 | 55 | 7:01 | 2 | 0 | 2 |
| Embodiment 7 | 2 | 52 | 104 | 188 | 55 | 7:01 | 2 | 0 | 3 |
| Embodiment 8 | 1 | 45 | 80 | 168 | 55 | 7:01 | 2 | 0 | 3 |
| Embodiment 9 | 2 | 55 | 115 | 198 | 55 | 8:01 | 2 | 0 | 2 |
| Embodiment 10 | 1 | 50 | 100 | 180 | 55 | 7:01 | 1 | 0 | 3 |
| Embodiment 11 | 1 | 50 | 100 | 180 | 55 | 7:01 | 5 | 0 | 2 |
| Embodiment 12 | 1 | 50 | 100 | 180 | 55 | 7:01 | 9 | 0 | 2 |
| Embodiment 13 | 1 | 55 | 100 | 180 | 60 | 7:01 | 25 | 0 | 2 |
| Embodiment 14 | 0.4 | 50 | 100 | 180 | 55 | 18:01 | 2 | 0 | 2 |
| Embodiment 15 | 6 | 50 | 100 | 180 | 55 | 1:03 | 2 | 0 | 3 |
| Embodiment 16 | 7 | 50 | 100 | 180 | 55 | 1:07 | 2 | 0 | 2 |
| Embodiment 17 | 1 | 50 | 100 | 180 | 55 | 7:01 | 2 | 0 | 3 |
| Embodiment 18 | 1 | 50 | 100 | 180 | 55 | 7:01 | 2 | 0 | 2 |
| Embodiment 19 | 1 | 50 | 100 | 180 | 55 | 7:01 | 2 | 0 | 3 |
| Embodiment 20 | 1 | 50 | 100 | 180 | 55 | 7:01 | 2 | 0 | 2 |
| Embodiment 21 | 1 | 50 | 100 | 180 | 55 | 7:01 | 2 | 0 | 2 |
| Embodiment 22 | 1 | 50 | 100 | 180 | 55 | 7:01 | 2 | 0 | 2 |
| Embodiment 23 | 1 | 50 | 100 | 180 | 55 | 7:01 | 2 | 0 | 2 |
| Embodiment 24 | 1 | 50 | 100 | 180 | 55 | 7:01 | 2 | 0 | 3 |
| Embodiment 25 | 1 | 50 | 100 | 180 | 55 | 7:01 | 2 | 0 | 2 |
| Comparative | / | 55 | 100 | 198 | 55 | / | / | 0 | 2 |
| Embodiment 1 | | | | | | | | | |
| Comparative | / | 55 | 100 | 198 | 55 | / | 2 | 0 | 3 |
| Embodiment 2 | | | | | | | | | |
| Comparative | 10 | 55 | 100 | 198 | 55 | / | / | / | / |
| Embodiment 3 | | | | | | | | | |
| Comparative | / | / | / | / | / | / | / | / | / |
| Embodiment 4 | | | | | | | | | |
| Comparative | 0.7 | 50 | 100 | 180 | 55 | 7:01 | 35 | 0 | 2 |
| Embodiment 5 | | | | | | | | | |
| Comparative | 0.3 | 50 | 100 | 180 | 55 | 25:01:00 | 2 | 0 | 2 |
| Embodiment 6 | | | | | | | | | |
| Comparative | 1 | 5 | 10 | 180 | 10 | 7:01 | 2 | 0 | 2 |
| Embodiment 7 | | | | | | | | | |
| Comparative | 5 | 250 | 500 | 180 | 255 | 7:01 | 2 | 0 | 3 |
| Embodiment 8 | | | | | | | | | |
| Comparative | 3.3 | 250 | 500 | 180 | 255 | 7:01 | 35 | 0 | 3 |
| Embodiment 9 | | | | | | | | | |
| Comparative | 1 | 250 | 500 | 180 | 255 | 25:01:00 | 35 | 0 | 2 |
| Embodiment 10 | | | | | | | | | |

| | Length-to- | | | | | | |
|---|---|---|---|---|---|---|---|
| | diameter | | Thickness | | | | Number |
| | ratio of | | change | Electrical | Electrical | Coulombic | of |
| | one-dimensional | Porosity | rate | conductivity | conductivity | efficiency | cycles |
| | material | (%) | (%) | a (S/cm) | b (S/cm) | (%) | (cls) |
| Embodiment 1 | 10000- | 85 | 5 | 105 | 890 | 99.5 | 325 |
| | 12000 | | | | | | |
| Embodiment 2 | 7500- | 86 | 5 | 105 | 890 | 99.4 | 295 |
| | 12000 | | | | | | |
| Embodiment 3 | 10000- | 85 | 5 | 105 | 890 | 99.4 | 285 |
| | 15000 | | | | | | |
| Embodiment 4 | 7500- | 86 | 20 | 105 | 890 | 99.3 | 268 |
| | 10000 | | | | | | |
| Embodiment 5 | 8500- | 86 | 0 | 105 | 890 | 99.3 | 284 |
| | 10000 | | | | | | |
| Embodiment 6 | 9500- | 87 | 6 | 105 | 890 | 99.3 | 296 |
| | 12000 | | | | | | |
| Embodiment 7 | 7500- | 86 | 5 | 105 | 890 | 99.4 | 309 |
| | 10000 | | | | | | |
| Embodiment 8 | 7800- | 86 | 5 | 105 | 890 | 99.4 | 316 |
| | 10000 | | | | | | |
| Embodiment 9 | 9000- | 87 | 7 | 105 | 890 | 99.1 | 265 |
| | 12000 | | | | | | |
| Embodiment 10 | 9500- | 87 | 5 | 105 | 890 | 99.3 | 302 |
| | 11000 | | | | | | |
| Embodiment 11 | 8700- | 86 | 5 | 105 | 890 | 99.3 | 318 |
| | 11000 | | | | | | |
| Embodiment 12 | 9600-1200 | 87 | 5 | 105 | 890 | 99.3 | 321 |
| Embodiment 13 | 7500- | 86 | 9 | 105 | 890 | 99.1 | 231 |
| | 10000 | | | | | | |
| Embodiment 14 | 7900- | 87 | 8.5 | 105 | 890 | 99.2 | 235 |
| | 11000 | | | | | | |
| Embodiment 15 | 9400- | 87 | 7.1 | 105 | 890 | 99.3 | 250 |
| | 12000 | | | | | | |
| Embodiment 16 | 9200- | 87 | 8.7 | 105 | 890 | 99.4 | 241 |
| | 12000 | | | | | | |
| Embodiment 17 | 7500- | 88 | 5 | 86 | 890 | 99.4 | 316 |
| | 12000 | | | | | | |
| Embodiment 18 | 7900- | 88 | 7 | 105 | 741 | 99.4 | 289 |
| | 11000 | | | | | | |
| Embodiment 19 | 8800- | 86 | 5 | 105 | 890 | 99.5 | 328 |
| | 12000 | | | | | | |
| Embodiment 20 | 9500- | 86 | 5.1 | 105 | 890 | 99.5 | 318 |
| | 11000 | | | | | | |
| Embodiment 21 | 7400- | 86 | 5 | 105 | 890 | 99.5 | 321 |
| | 12000 | | | | | | |
| Embodiment 22 | 7900- | 60 | 6 | 105 | 890 | 99.1 | 224 |
| | 10000 | | | | | | |
| Embodiment 23 | 8400- | 40 | 9.5 | 105 | 890 | 99 | 205 |
| | 11000 | | | | | | |
| Embodiment 24 | 8500- | 30 | 10 | 105 | 890 | 99 | 212 |
| | 10000 | | | | | | |
| Embodiment 25 | 10000- | 85 | 5 | 105 | 890 | 99.5 | 289 |
| | 12000 | | | | | | |
| Comparative | 8500- | 65 | 16 | 105 | / | 98.7 | 185 |
| Embodiment 1 | 1100 | | | | | | |
| Comparative | 9100- | 86 | 12 | 105 | / | 99 | 200 |
| Embodiment 2 | 12000 | | | | | | |
| Comparative | / | 90 | 14 | / | 890 | 98.4 | 165 |
| Embodiment 3 | | | | | | | |
| Comparative | / | / | 20 | / | / | 97.7 | 24 |
| Embodiment 4 | | | | | | | |
| Comparative | 7900- | 86 | 17 | 105 | 890 | 98.1 | 157 |
| Embodiment 5 | 10000 | | | | | | |
| Comparative | 8400- | 87 | 17 | 105 | 890 | 98.2 | 163 |
| Embodiment 6 | 10000 | | | | | | |
| Comparative | 7900- | 86 | 17 | 105 | 890 | 98.5 | 176 |
| Embodiment 7 | 12000 | | | | | | |
| Comparative | 7600- | 86 | 16 | 105 | 890 | 98.3 | 165 |
| Embodiment 8 | 10000 | | | | | | |
| Comparative | 10500- | 86 | 18 | 105 | 890 | 98.1 | 143 |
| Embodiment 9 | 11000 | | | | | | |
| Comparative | 9400- | 85 | 16 | 105 | 890 | 98.4 | 156 |
| Embodiment 10 | 11000 | | | | | | |

Note:
“/” in Table 1 indicates absence of the corresponding preparation parameter or performance parameter. [symbol]
indicates data missing or illegible when filed

As can be seen from Embodiments 1 to 25 and Comparative Embodiments 1 to 10, when the three-dimensional framework prepared in an embodiment of this application is applied to a lithium metal battery, the Coulombic efficiency is higher, and a larger number of cycles is achieved. Therefore, the lithium metal battery in an embodiment of this application achieves a higher level of Coulombic efficiency and cycle performance. In addition, the thickness change rate of the three-dimensional framework is relatively low, thereby improving the expansion resistance of the lithium metal battery.

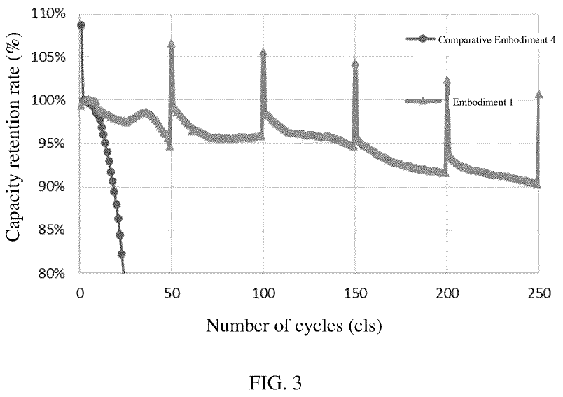

Specifically, FIG. 2 is a scanning electron microscope (SEM) image of a three-dimensional framework according to Embodiment 1. As can be seen from the drawing, the three-dimensional framework assumes a three-dimensional structure, and there are pores in the three-dimensional framework. FIG. 3 shows a capacity fading curve of a lithium metal battery according to Embodiment 1 and Comparative Embodiment 4. As can be seen from the drawing, the capacity retention rate of the lithium metal battery in Comparative Embodiment 4 drops to 80% at the end of 24 cycles. In contrast, the capacity retention rate of the lithium metal battery in Embodiment 1 basically remains at 90% or above at the end of 250 cycles. The test results show that the lithium metal battery according to this application is superior in cycle performance.

As can be seen from Embodiment 1 and Comparative Embodiments 1 to 4, the lithium metal battery exhibits a higher level of Coulombic efficiency and cycle performance when the second framework layer includes the zero-dimensional material, the one-dimensional material, and the two-dimensional material concurrently.

As can be seen from Embodiment 1, Embodiments 10 to 13, and Comparative Embodiment 5, the lithium metal battery exhibits a higher level of Coulombic efficiency and cycle performance when the mass percent of the zero-dimensional material falls within the range specified herein.

As can be seen from Embodiment 1, Embodiments 14 to 16, and Comparative Embodiment 6, the lithium metal battery exhibits a higher level of Coulombic efficiency and cycle performance when the mass ratio between the one-dimensional material and the two-dimensional material falls within the range specified herein.

As can be seen from Embodiment 1 and Comparative Embodiments 7 and 8, the lithium metal battery exhibits a higher level of Coulombic efficiency and cycle performance when the thicknesses of the second framework layer and the three-dimensional framework fall within the ranges specified herein.

As can be seen from Embodiment 1 and Comparative Embodiments 9 and 10, the lithium metal battery exhibits a higher level of Coulombic efficiency and cycle performance when the thickness of the three-dimensional framework, the thickness of the first framework layer, the thickness of the second framework layer, the mass percent of the zero-dimensional material, and the mass ratio between the one-dimensional material and the two-dimensional material all fall within the ranges specified herein.

The thickness of the first framework layer usually affects the performance of the lithium metal battery. As can be seen from Embodiment 1 and Embodiments 6 to 9, the lithium metal battery exhibits relatively high Coulombic efficiency and good cycle performance when the thickness of the first framework layer falls within the range specified herein.

The type of the one-dimensional conductive fibers in the first framework layer and the types of the one-, two-, and zero-dimensional materials in the second framework layer usually affect the performance of the lithium-metal battery. As can be seen in Embodiment 1, Embodiments 17 to 21, and Embodiment 25, the lithium metal battery exhibits relatively high Coulombic efficiency and good cycle performance when the type of the one-dimensional conductive fibers in the first framework layer and the types of the one-, two-, and zero-dimensional materials in the second framework layer fall within the ranges specified herein. As can be seen from Embodiments 1 to 25, when the thickness of the three-dimensional framework, the thickness of the first framework layer, the thickness of the second framework layer, the mass percent of the zero-dimensional material, and the mass ratio between the one-dimensional material and the two-dimensional material all fall within the ranges specified herein, the three-dimensional framework exhibits a relatively high porosity and a relatively low thickness change rate, and the one-dimensional material and the two-dimensional material exhibit a relatively high electrical conductivity. Therefore, the lithium metal battery exhibits relatively high Coulombic efficiency and good cycle performance.

The particle diameter of the zero-dimensional material as well as the diameter and the length-to-diameter ratio of the one-dimensional material usually affect the performance of the lithium metal battery. As can be seen from Embodiments 1 to 25, the lithium metal battery exhibits relatively high Coulombic efficiency and good cycle performance when the particle diameter of the zero-dimensional material as well as the diameter and the length-to-diameter ratio of the one-dimensional material fall within the ranges specified herein.

It is hereby noted that the relational terms herein such as first and second are used only to differentiate one entity or operation from another, but do not require or imply any actual relationship or sequence between the entities or operations. Moreover, the terms “include”, “comprise”, and any variations thereof are intended to cover a non-exclusive inclusion relationship by which a process, method, object, or device that includes or comprises a series of elements not only includes such elements, but also includes other elements not expressly specified or also includes inherent elements of the process, method, object, or device.

Different embodiments of this application are described in a correlative manner. For the same or similar part in one embodiment, reference may be made to another embodiment. Each embodiment focuses on differences from other embodiments.

What is described above is merely preferred embodiments of this application, but not intended to limit the protection scope of this application. Any modifications, equivalent replacements, improvements, and the like made without departing from the spirit and principles of this application still fall within the protection scope of this application.

What is claimed is:

1. A secondary battery, comprising: a negative electrode plate and a separator; wherein the negative electrode plate comprises a three-dimensional framework, the three-dimensional framework comprises a first framework layer and a second framework layer; the first framework layer comprises one-dimensional conductive fibers; the second framework layer comprises a zero-dimensional material, a one-dimensional material, and a two-dimensional material, and the zero-dimensional material is a lithiophilic material;
a thickness of the three-dimensional framework is 10 μm to 200 μm, a thickness of the first framework layer no greater than 10 μm, and a thickness of the second framework layer is 10 μm to 200 μm; and
based on a mass of the second framework layer, a mass percent of the zero-dimensional material is 1% to 30%, and a mass ratio between the one-dimensional material and the two-dimensional material is 1:7 to 20:1.

2. The secondary battery according to claim 1, wherein the negative electrode plate comprises a metallic lithium layer, the second framework layer is located between the first framework layer and the metallic lithium layer, and a thickness of the metallic lithium layer is 1 μm to 100 μm.

3. The secondary battery according to claim 2, wherein the thickness of the metallic lithium layer is 5 μm to 50 μm.

4. The secondary battery according to claim 1, wherein a thickness of the three-dimensional framework is 30 μm to 180 μm, and the thickness of the second framework layer is 30 μm to 80 μm.

5. The secondary battery according to claim 1, wherein the mass percent of the zero-dimensional material is 1% to 10%.

6. The secondary battery according to claim 1, wherein a particle diameter of the zero-dimensional material is 0.1 μm to 5 μm.

7. The secondary battery according to claim 1, wherein a diameter of the one-dimensional material is 1 nm to 2000 nm, and a length-to-diameter ratio of the one-dimensional material is 0.1 to 20000.

8. The secondary battery according to claim 1, wherein a particle diameter of the zero-dimensional material is 0.1 μm to 1 μm.

9. The secondary battery according to claim 1, wherein a diameter of the one-dimensional material is 1 nm to 300 nm, and a length-to-diameter ratio of the one-dimensional material is 0.67 to 20000.

10. The secondary battery according to claim 1, wherein a diameter of the one-dimensional material is 1 nm to 50 nm, and a length-to-diameter ratio of the one-dimensional material is 5000 to 20000.

11. The secondary battery according to claim 1, wherein the two-dimensional material comprises titanium, carbon, and a surface group; and the surface group comprises at least one of —F, —O, or —OH.

12. The secondary battery according to claim 1, wherein an electrical conductivity a of the one-dimensional material satisfies: a≥1×10⁻⁶ S/cm, and an electrical conductivity b of the two-dimensional material satisfies: b≥2 S/cm, and b>a.

13. The secondary battery according to claim 1, wherein the one-dimensional conductive fibers comprise at least one of multi-walled carbon nanotubes, carbon nanofibers, a silver wire, or a nickel wire; the zero-dimensional material comprises at least one of a metal material, an oxide, a nitride, a sulfide, or a carbide; the metal material comprises at least one of Ag, Au, Zn, or an alloy thereof, the oxide comprises at least one of TiO₂, SiO₂, ZnO, SnO₂, Co₃O₄, or Fe₂O₃; the nitride comprises Mo₂N₃ and/or Fe₆N₃; the sulfide comprises MoS₂ and/or SnS₂; the carbide comprises FeC; the one-dimensional material comprises at least one of multi-walled carbon nanotubes, carbon nanofibers, a silver wire, or a nickel wire; and the two-dimensional material comprises MXene and/or graphene.

14. The secondary battery according to claim 13, wherein a surface of the zero-dimensional material contains a wetting group, wherein the wetting group comprises at least one of —OH, —COOR, —COOH, —NH₂, or —SO₃H, and R in —COOR is selected from methyl, ethyl, propyl, vinyl, or ethynyl.

15. The secondary battery according to claim 1, wherein a porosity of the three-dimensional framework is greater than or equal to 80%.

16. The secondary battery according to claim 1, wherein a thickness change rate of the three-dimensional framework is less than 10% when lithium metal is deposited in the three-dimensional framework at a concentration of 5 μmAh/cm².

17. An electronic device, comprising a secondary battery, the secondary battery comprise a negative electrode plate and a separator, wherein the negative electrode plate comprises a three-dimensional framework; the three-dimensional framework comprises a first framework layer and a second framework layer; the first framework layer comprises one-dimensional conductive fibers; the second framework layer comprises a zero-dimensional material, a one-dimensional material, and a two-dimensional material; and the zero-dimensional material is a lithiophilic material;
a thickness of the three-dimensional framework is 10 μm to 200 μm, a thickness of the first framework layer is 0 μm to 10 μm, and a thickness of the second framework layer is 10 μm to 200 m; and
based on a mass of the second framework layer, a mass percent of the zero-dimensional material is 1% to 30%, and a mass ratio between the one-dimensional material and the two-dimensional material is 1:7 to 20:1.
